(19) United States
(12) Patent Application Publication
(10) Pub. No.: US 2005/0126032 A1
(43) Pub. Date: Jun. 16, 2005

(54) Roller conveyor turn system

(75) Inventor: Jared E. Ufland, Los Angeles, CA (US)

Correspondence Address: MORRISON & FOERSTER, LLP, 555 WEST FIFTH STREET, SUITE 3500, LOS ANGELES, CA, 90013-1024, US

(73) Assignee: National Conveyor Corporation, Commerce, CA (US)

(21) Appl. No.: 11/014,264

(22) Filed: Dec. 15, 2004

Related U.S. Application Data
(60) Provisional application No. 60/529,652, filed on Dec. 15, 2003.

(51) Int. Cl. F26B 19/00; F26B 25/00

(52) U.S. Cl. 34/236

(57) ABSTRACT

An improved roller drying table turn corner is provided, which prevents dishracks from jamming as they traverse a turn on a roller drying table. The improved roller drying table turn corner may include a guiding rod having a cross-sectional shape that prevents the corner of the dishrack from catching thereon. In one embodiment, the guiding rod has a circular cross-sectional shape. In another embodiment, the guiding rod is offset a certain distance from the rollers. In another embodiment, additional rollers are provided along the outer half of the split roller section around the turn of the roller drying table turn corner.

### CROSS-REFERENCE TO RELATED APPLICATIONS

This application claims priority to U.S. provisional application Ser. No. 60/529,652 entitled “Roller Conveyor Turn System,” filed Dec. 15, 2003, the contents of which are incorporated herein by reference for all purposes.

### BACKGROUND OF THE INVENTION

A very large percentage of the commercial dishmachines used in the foodservice industry are called “conveyorized rack type” machines. These machines universally use a 19.75 in. square dishrack. When the dishrack (with clean ware) exists the dishmachine, it discharges onto a stainless steel table that is called a “clean dishtable.” While the dishracks were originally made of stainless steel wire, in the last 30 years the industry has turned to plastic dishracks, made primarily of polypropylene. Originally, and up until approximately the last 10 years, the “clean dishtables” were also made of stainless steel and the dishrack was pushed along by a conveyor inside the dishmachine. Over the last 10 years or so, the clean dishtables have evolved into what is referred to as “roller drying tables.” The rollers aid in air drying the ware and reduce the friction on the plastic dishracks, thereby eliminating the “fraying” on the dishrack bottoms due to the soft material thereof. The rollers therefore extend the usable life of the dishracks.

Generally, the configuration of the roller drying tables is such that a 90° turn is required at some point along the length thereof. With respect to the rollers, a split roller system is employed in which two rollers are positioned on one shaft as illustrated in FIG. 1. The reason for this is that the outside of the dishrack is actually moving slower than the inside thereof and thus, the split rollers compensate for this phenomena. Due to this configuration, the dishrack must be guided around the turn. Unfortunately, this has presented problems. Foremost among the typical problems is jamming of the dishracks. Because the typical guide is a flat piece of stainless steel bent to follow the radius of the turn and attached directly adjacent the outside roller, as shown in FIGS. 2 and 3, respectively, the dishrack, generally possessing sharp corners, tends to get caught as it makes contact with the guide as the leading outside corner of the dishrack contacts the flat surface of the guide. Once a dishrack is detained for any length of time, subsequent following dishracks back up and potentially shut down the entire system. In order to avoid shutdown, additional distance has been provided to the roller drying table prior to the turn so that in the event of a jam, the operator will have time to manually guide the jammed dishrack through the turn. The minimum distance to allow for such action is purportedly 48 inches from the exit of the dishmachine to the far corner of the dishtable. However, as one can imagine, the use of additional space can become problematic and/or costly.

Thus, it would be advantageous to provide a turn guide system that would prevent dishracks from jamming as they traversed a turn. It would also be advantageous to provide a system that would allow for a shorter distance from the dishmachine to the turn.

### BRIEF SUMMARY OF THE INVENTION

Accordingly, an improved roller drying table turn corner is provided, which prevents dishracks from jamming as they traverse a turn on a roller drying table. As used herein, the term “roller drying table turn corner” refers to any section on a roller drying table that forms an angle with respect to a preceding section of the table.

The improved roller drying table turn corner may be comprised of a guiding rod having a cross-sectional shape that prevents the corner of the dishrack from catching thereon. In one embodiment, the guiding rod has a circular cross-sectional shape. In another embodiment, the guiding rod is offset a certain distance from the rollers. In yet another embodiment, additional rollers are provided along the outer half of a split roller section around the turn of the roller drying table turn corner.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 is a top view of the prior art roller drying table turn corner.

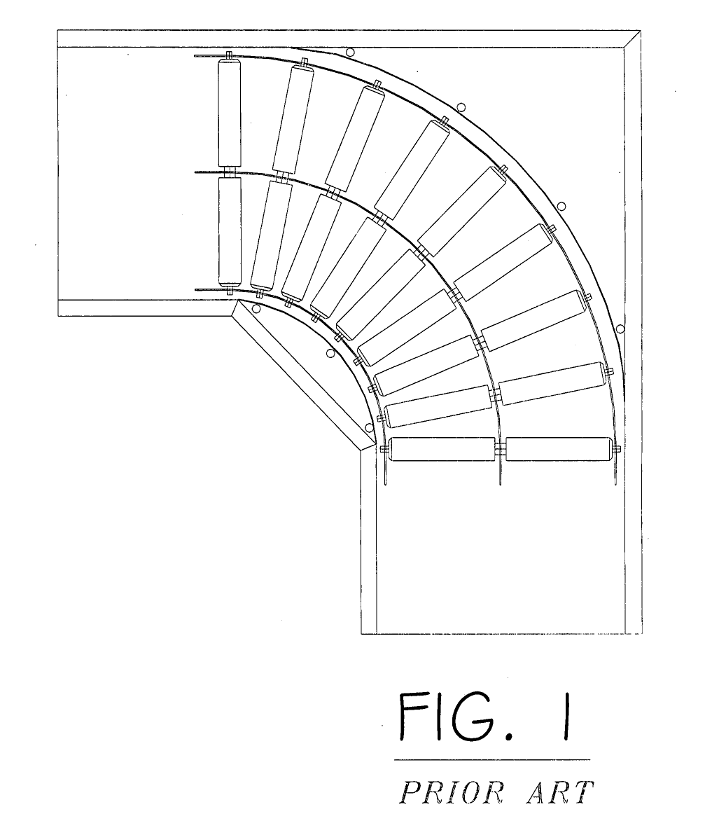

FIG. 2 is an isolated view of the prior art turn guide for the roller drying table turn corner of FIG. 1.

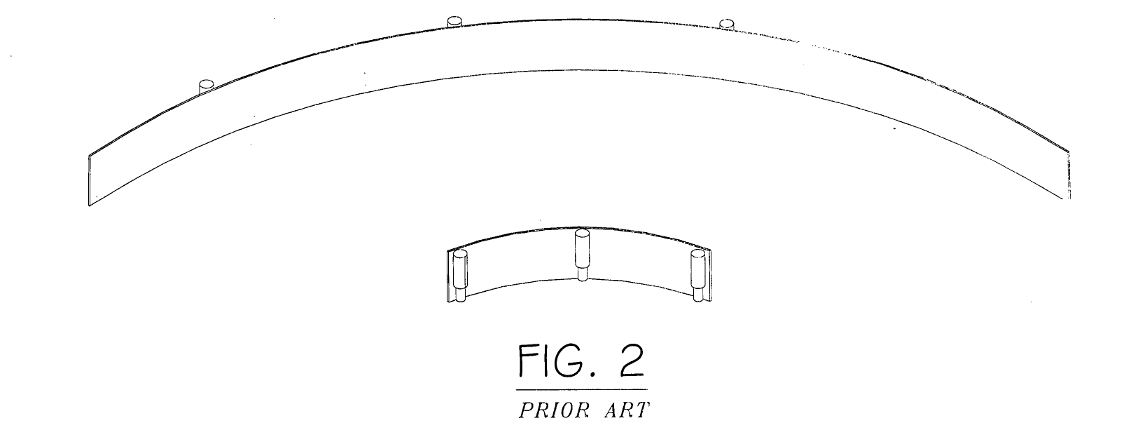

FIG. 3 is a cross-sectional end view of the roller drying table turn corner depicted in FIG. 1.

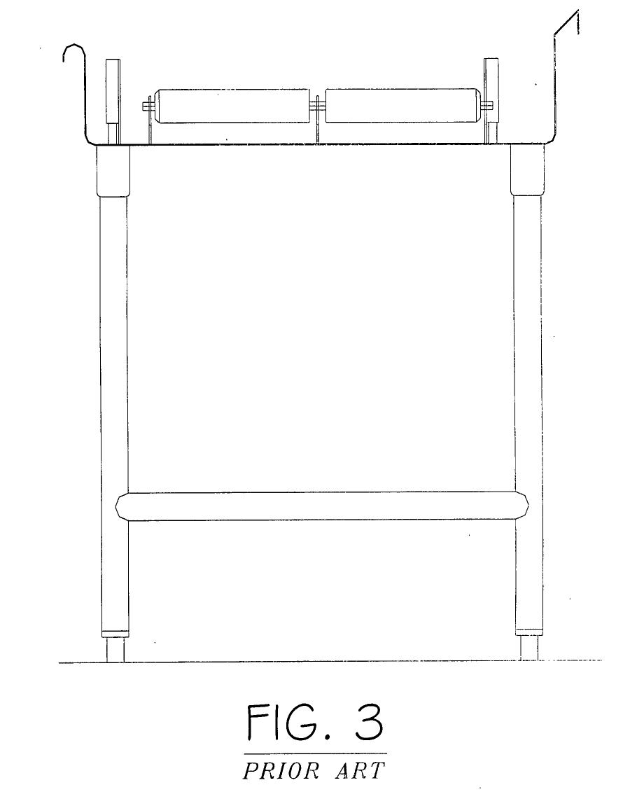

FIG. 4 is a perspective view of a section of the improved roller drying table turn corner according to the present invention.

FIG. 5 is a top view of the section of the improved roller drying table turn corner shown in FIG. 4.

FIG. 6 is a cross-sectional end view of the improved roller drying table turn corner shown in FIG. 4.

FIG. 7 is an isolated view of the guiding rods on the improved roller drying table turn corner shown in FIG. 4.

### DETAILED DESCRIPTION OF THE INVENTION

The following detailed description should be read with reference to the drawings, in which like elements in different drawings are identically numbered. The drawings, which are not necessarily to scale, depict selected preferred embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

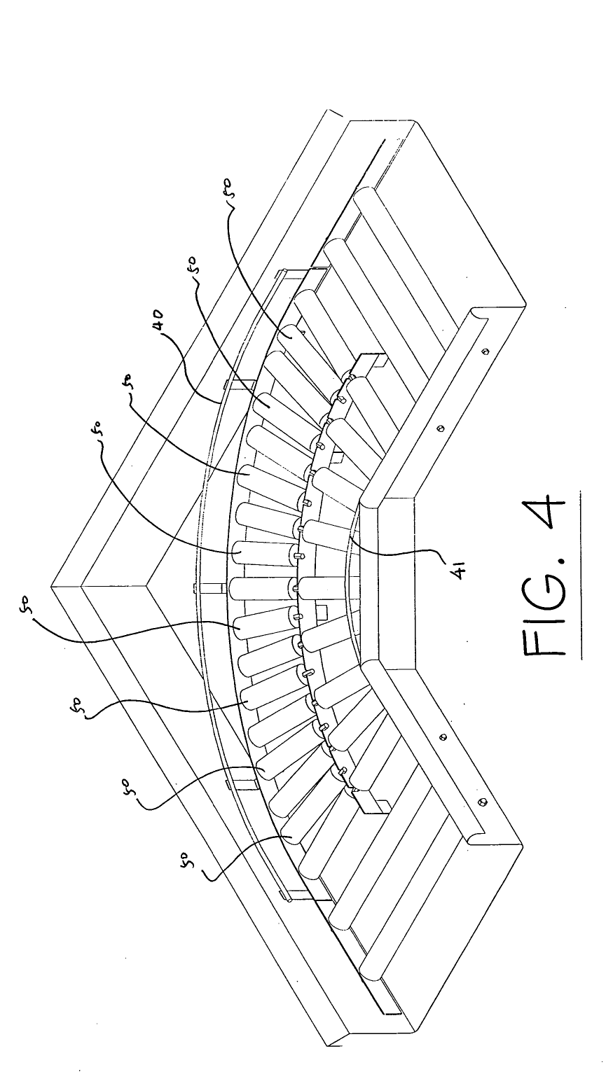

The present invention provides an improvement to a roller drying table turn corner, utilizing important features either alone or in combination to prevent jamming of dishracks and to allow for a shorter distance from the dishmachine to a turn on a roller drying table. These improvements may comprise the use of a rod rather than a flat sheet, offsetting the rod from the rollers, and/or the use of additional, intermediate rollers around the turn on a roller drying table turn corner. The three features discussed can be seen with reference to FIG. 4, which is a perspective view of the roller drying table turn corner of the present invention. In particular, the use of a rod with circular cross-sectional configuration can be seen to create an outside and inside railing 40, 41 for guiding the dishracks (dishracks not shown). Because of the rounded surface of the rods, a dishrack having an orthogonal shape will not jam when coming in contact therewith, in contrast to the flat sheet of the prior art. Specifically, the sharp corners of the dishrack will tend to ride along the rod or bounce off, rather than stick. Of course, one of skill in the art should appreciate that the cross-sectional configuration of the rod could be oval or other like shapes as long as the surface facing the dishrack passing by is not flat or otherwise configured such that the corner of the dishrack would tend to get caught.

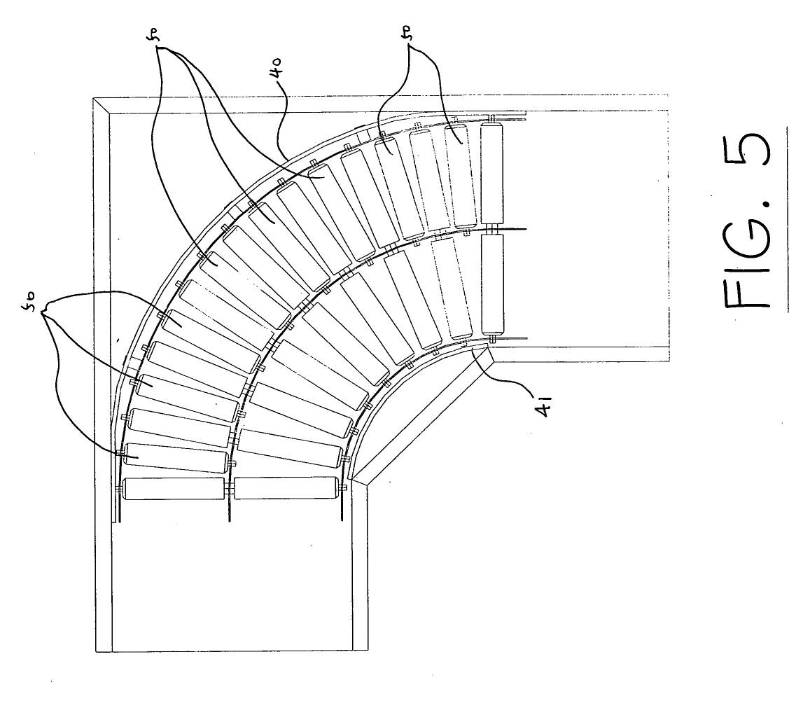

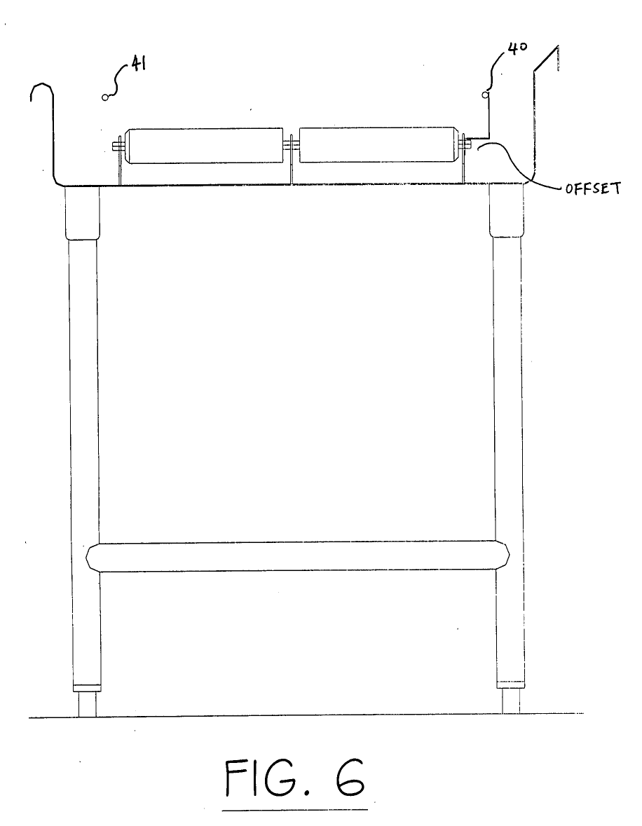

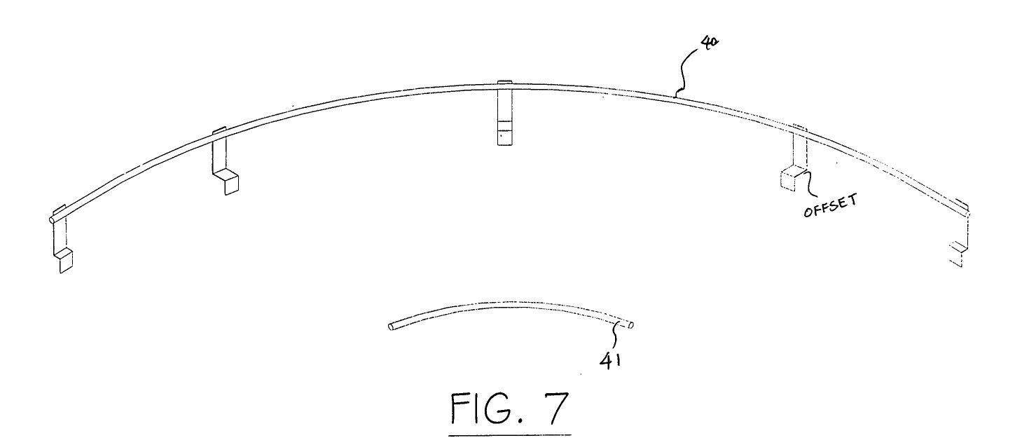

With reference to FIG. 5, which is a top view of FIG. 4, the offset configuration of the rods can be seen in relation to the rollers. By offsetting the rods from the rollers, the dishracks are permitted to drift outward without increasing the depth of the table, which feature has also been demonstrated to prevent jamming around the roller drying table turn corner. This feature can be even more clearly seen in FIG. 6, which is a cross-sectional end view of the system shown in FIGS. 4 and 5, and in FIG. 7, which is an isolated view of the inner and outer railings. Referring back to FIG. 4, the additional intermediate rollers 50 can be seen on the outer half of the split-roller portion around the turn. The presence of additional rollers 50 further compensates for the slower moving outside of the dishrack in relation to the inside thereof, maintaining an even speed for the entire dishrack, thereby also reducing the potential for jamming.

The present invention has been described above in terms of certain preferred embodiments so that an understanding of the present invention can be conveyed. However, there are many alternative arrangements not specifically described herein, but with which the present invention is applicable. Although specific features have been provided, the present invention would equally be embodied by other configurations not specifically recited herein. The scope of the present invention should therefore not be limited by the embodiments illustrated, but rather it should be understood that the present invention has wide applicability with respect to catheter systems generally. All modifications, variations, or equivalent elements and implementations that are within the scope of the appended claims should therefore be considered within the scope of the invention.

1. An roller drying table turn corner for drying dishracks exiting a dishmachine, said roller drying table turn corner having a plurality of rollers and comprising a guiding rod positioned along at least a portion thereof.

2. The roller drying table turn corner according to claim 1, wherein said guiding rod has a circular cross-sectional shape.

3. The roller drying table turn corner according to claim 1, wherein said guiding rod is offset a distance from said rollers.

4. The roller drying table turn corner according to claim 1, wherein said plurality of rollers comprises split rollers divided into an inner set and an outer set, wherein the number of rollers in said outer said is greater than the number of rollers in said inner set.

5. An roller drying table turn corner for drying dishracks exiting a dishmachine, said roller drying table turn corner having a plurality of rollers and comprising a guiding rod positioned along at least a portion thereof, wherein said guiding rod has a circular cross-sectional shape and is offset a distance from said rollers.
